(19) United States
(12) Patent Application Publication
(10) Pub. No.: US 2003/0196858 A1
(43) Pub. Date: Oct. 23, 2003

(54) Brake plate

(76) Inventors: Vin C Morley, Balcatta (AU); Stan Nowak, Balcatta (AU); Dorota Kieronska, Balcatta (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/343,680

(22) PCT Filed: Nov. 29, 2000
(86) PCT No.: PCT/AU00/01470

(30) Foreign Application Priority Data
Aug. 1, 2000 (AU) PR 0445

(51) Int. Cl. F16D 55/02

(52) U.S. Cl. 188/71.6

(57) ABSTRACT

A brake plate (10) adapted for use in a wet brake system (24) having at least one disc rotatable about its axis through a volume of a liquid, said brake plate (10) including at least a plate body (12); a braking surface (14) on one radial face (16) of said plate scraper (18) extends axially beyond the braking surface (14) and a second position where said scraper (18) is retracted axially to lie substantially flush with or below the braking surface (14).

### FIELD OF THE INVENTION

The present invention relates to a brake plate, and in particular, but not exclusively, to a brake plate for use in a wet brake system.

### BACKGROUND OF THE INVENTION

The Applicant is the proprietor of various inventions relating to wet brake systems and components thereof as described, for example, in International Application Nos. PCT/AU92/00540, PCT/AU95/00529 and PCT/AU97/00500, the contents of which are incorporated herein by way of reference.

In broad terms, a wet brake system typically includes a disc fixed to rotate with a rotating component such as an axle, and a pair of brake pads, one on each side of the disc, with the disc and brake pads disposed within a seal housing containing a volume of oil.

Wet brake systems enjoy various benefits over dry brake systems including: a substantially reduced rate of wear of brake pads; the ability to isolate contacting surfaces of the disc and pads from foreign matter and debris that may otherwise adversely effect performance or increase the rate of wear; and, the containment of dust from the brake pads.

### SUMMARY OF THE INVENTION

It is an object of the present invention to provide a brake plate that can further enhance the performance of a wet brake system.

According to the present invention there is provided a brake plate adapted for use in a wet brake system having at least one disc rotatable about its axis through a volume of a liquid, said brake plate including at least:

a plate body;

a braking surface on one radial face of said plate body; and,

at least one scraping means supported by said plate body and axially moveable between a first position where the scraping means extends axially beyond said braking surface and a second position where said scraping means is retracted axially to lie substantially flush with or below said braking surface.

Preferably, said brake plate includes bias means for biasing said scraping means towards said first position.

Preferably, each scraping means has a radial contact face for face to face contact with said disc, to scrape or wipe liquid from said disc.

Preferably, said contact face is provided with a peripheral edge and at least one groove extending between and opening onto two spaced apart points on said peripheral edge, said at least one groove providing a flow path through which liquid can flow.

Preferably, said peripheral edge includes opposite first and second lateral edges and opposite first and second radial edges extending between said first and second lateral edges, and said at least one groove includes one or more grooves extending between and opening onto any two of said lateral and radial edges.

Preferably, said braking surface is divided into a plurality of spaced apart sectors disposed circumferentially about said one radial face of said plate body and wherein one scraping means is disposed between at least one set of mutually adjacent sectors.

Preferably, each sector is provided with one or more grooves for providing corresponding flow paths for a liquid between two spaced apart points on a peripheral edge of said braking surface.

According to another aspect of the present invention there is provided a wet brake system including at least:

a disc adapted for coupling to a rotatable component to rotate with said component about an axis, said disc having first and second opposite radial faces;

at least one brake plate in accordance with the first aspect of the present invention, said at least one brake plate fixed against rotation but linearly moveable relative to said disc parallel to said axis, said at least one brake plate disposed in facing relationship with one radial face of said disc;

means for axially moving said brake plate relative to said disc between an engaged position where said braking surface is in engagement with a facing radial surface and a disengaged position where said braking surface is spaced from said facing radial surface; and,

a sealed housing in which said disc and brake plate reside, said housing containing a volume of liquid through which said disc rotates.

Preferably, said disc and said at least one brake plate are axially spaced when in the disengaged position, to the extent that said scraping means of said brake plate maintains contact with said facing radial surface of the disc.

### DESCRIPTION OF THE DRAWINGS

FIG. 1a is a plan view of a brake plate in accordance with the present invention;

FIG. 1b is a view of section 1-1 of FIG. 1a;

FIG. 2a is a plan view of one embodiment of a brake pad incorporated in the brake plate;

FIG. 2b is a view of section 2-2 of FIG. 2a;

FIG. 3 is a plan view of a second embodiment of a brake pad incorporated in the brake plate; and

FIG. 4 is a schematic representation of a wet brake system incorporating the brake plate depicted in FIG. 1a.

### DETAILED DESCRIPTION OF PREFERRED EMBODIMENTS

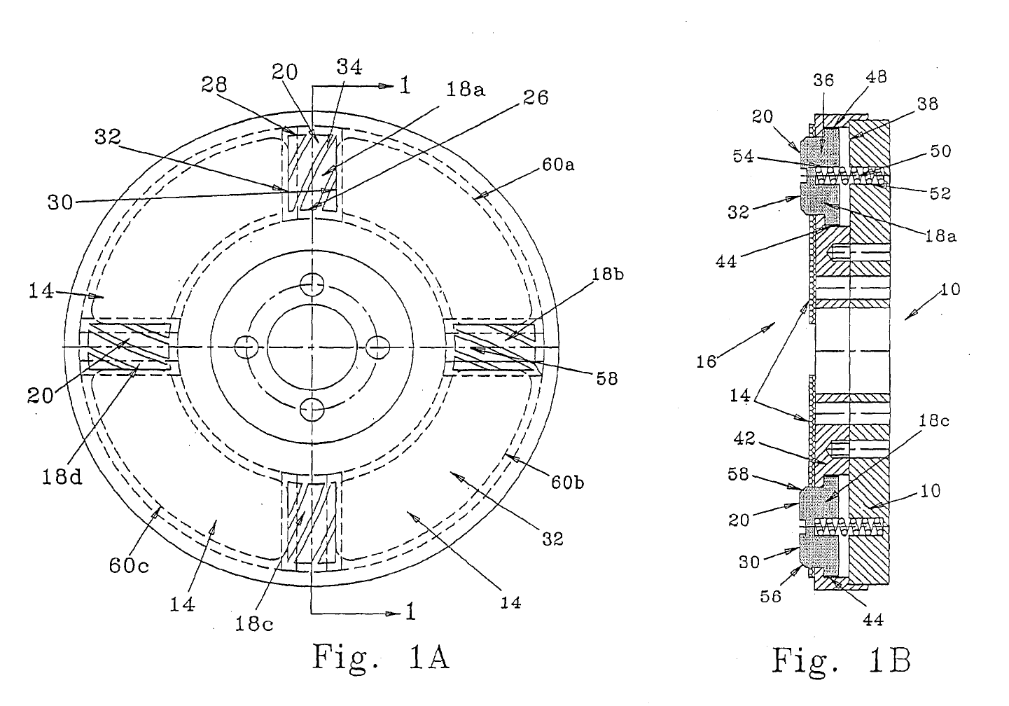

Referring to the accompanying drawings and in particular, FIGS. 1a and 1b, an embodiment of the brake plate 10 is shown as including a plate body 12 with a braking surface 14 on one radial face 16 of the plate body 12. At least one (in this particular embodiment four) scraper or wiper means 18a-18d (hereinafter referred to in general as “scrapers 18”) is supported by the plate body 12. The scrapers 18 are moveable axially between a first position where the scrapers 18 extend axially beyond the braking surface 14, as depicted in FIG. 1b, and a second position where the scrapers 18 are substantially flush with or below the braking surfaces 14.

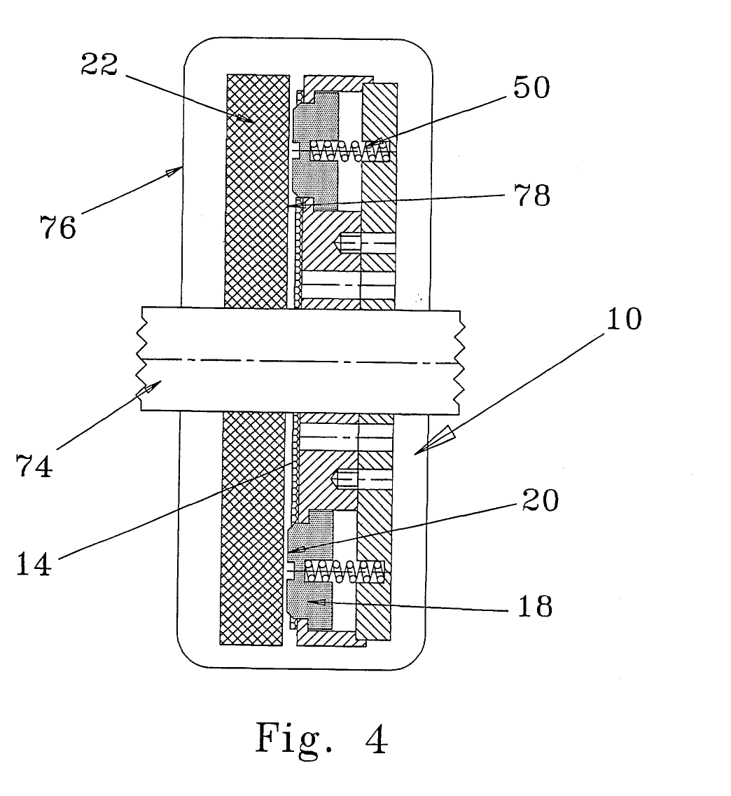

Each of the scrapers 18 has a substantially planar contact face 20 for face to face contact with a disc 22 in a disc brake system (see FIG. 4). Contact face 20 has a peripheral surface which is made up of a first lateral (or an inner circumferential) edge 26, a second lateral (or outer circumferential) edge 28, and opposite first and second radial edges 30 and 32 extending between the edges 26 and 28. A groove 34 is formed on the contact face 20 to provide a fluid flow path between two spaced apart points on thet peripheral edge of the contact face 20. In this particular embodiment, the groove 34 extends between and opens onto respective points on the edges 26 and 28 of the contact face 20.

Each of the scrapers 18 is in the form of a generally rectangular shaped block 36 of a wear resistant, and preferably self-lubricating, material such as PTFE or PTFE impregnated with boron or manganese bronze. Each block 36 is housed within a respective cavity 38 formed between a back plate 40 and front plate 42 of the plate body 12. The front plate 42 is provided with a plurality of apertures 44 through which the contact face 20 of respective scrapers 18 can extend. The width and breadth of the apertures 44 are smaller than the corresponding dimensions of the cavities 38. Each block 36 is provided with a laterally extending peripheral skirt 48 which is configured and dimensioned so as to be able to slide axially within cavity 38 but unable to pass through aperture 44. In this way, the scrapers 18 are retained to move axially within the cavities 38 of the brake plate 12.

Bias means in the form of one or more springs 50 are provided for biasing the scrapers 18 axially outwardly to a first position where the contact surface 20 extends axially beyond the braking surface 14. Opposite ends of each spring are retained within blind holes 52 and 54 formed in the back plate 40 and block 36 respectively. The springs 50 are provided with a degree of pre-load in order to hold the scrapers 18 axially outwardly to the maximum extent.

As seen most clearly in FIG. 1b, each of the scrapers 18 is provided with opposite radially extending bevelled surfaces 56 and 58. Bevelled surface 56 slopes away from the radial edge 30 and bevelled edge 58 slopes away from opposite radial edge 32.

Referring again to FIG. 1a, the braking surface 14 is divided into a plurality of spaced apart sectors 60a-60d (hereinafter referred to in general as “sectors 60”). Typically, the sectors 60 would each comprise a separate brake pad that can be coupled or otherwise attached to the brake plate 10 and more particularly the front plate 42. To this end, the front plate 42 is provided with a plurality of arcuate recesses (not shown) within which each sector 60 is seated.

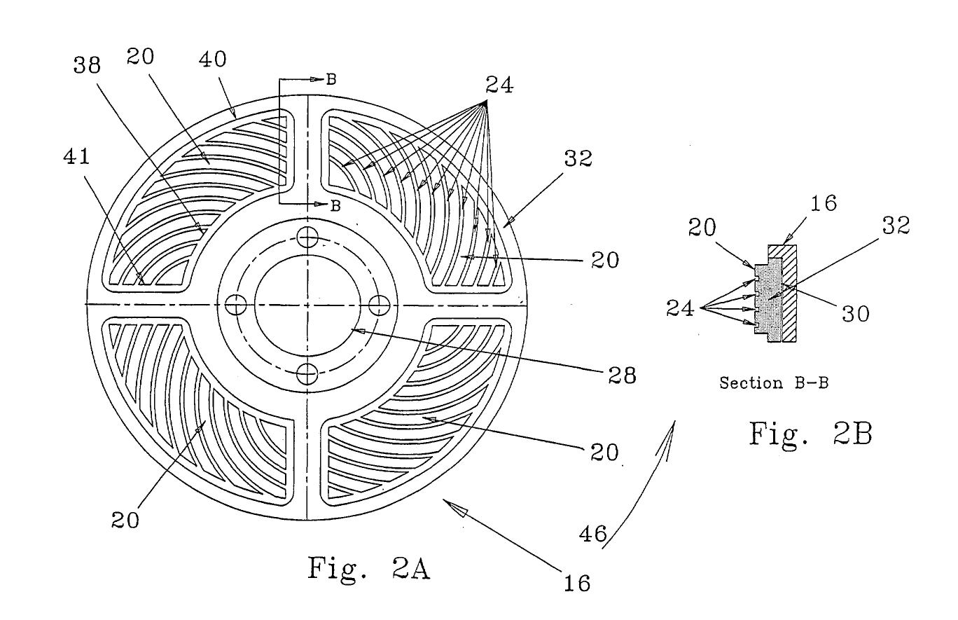

FIG. 2a and FIG. 2b depict one possible configuration of a sector/brake pad 60. The braking surface 14 is formed on an upper face of the sectors 60 and is bound by a first lateral (or inner circumferential) edge 62, second lateral (or outer circumferential) edge 64 and opposite radial edges 66 and 68 that extend between the inner and outer circumferential edges 62 and 64. The edges 62, 64, 66 and 68 which bound the braking surface 14 constitute the peripheral edge of the braking surface 14, and are all formed inboard of a laterally extending peripheral skirt 69 which seats in a corresponding recess (not shown) in the front plate 42. A plurality of grooves 70 are formed in the braking surface 14 of each sector 60 to provide fluid flow paths between two spaced apart points on the peripheral edge of the braking surface 14. For example, at least one groove 70a extends between inner circumferential edge 62 and outer circumferential edge 64, at least one further groove, groove 70b extends between inner circumferential edge 62 and radial edge 68, and at least one further groove 70c extends between the radial edge 66 and the outer circumferential edge 64.

When the brake plate 10 is used in a wet brake system the grooves 70 further assist in channelling oil or other liquid away from between the braking surface 14 and disc 22 during a braking operation.

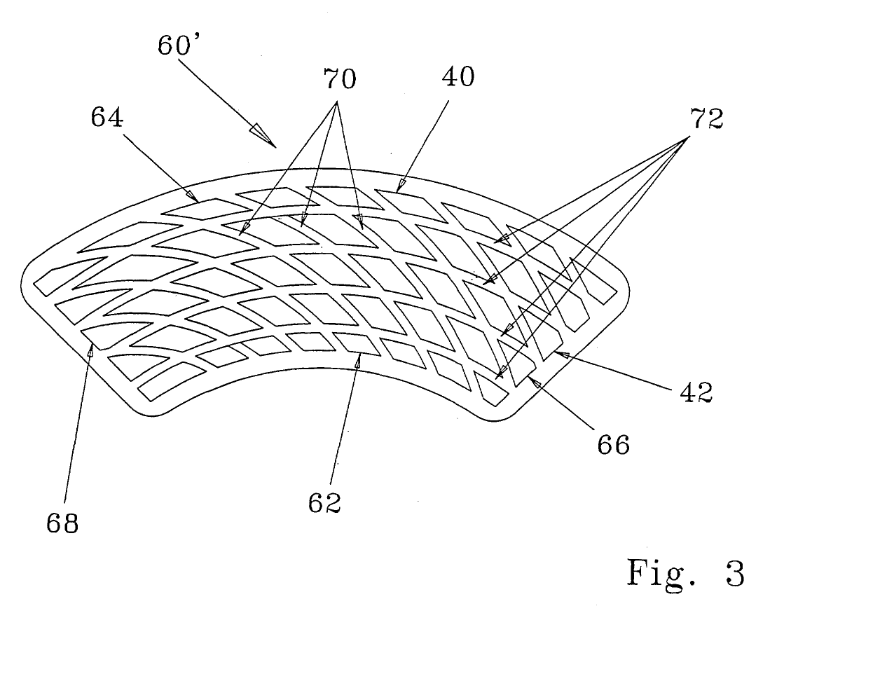

FIG. 3 depicts an alternative embodiment of the sector/brake pad 60′. This embodiment differs from the sector/brake pad 60 depicted in FIGS. 2a and 2b by the inclusion of four arcuate or circumferential extending grooves 72. Each groove 72 follows a curved path extending between opposite radial edges 66 and 68.

FIG. 4 depicts in a schematic and general sense a wet brake system 24 incorporating the brake plate 10. The system 24 includes a disc 22 mounted on a rotating component such as an axle 74, and a sealed housing 76 which encloses the disc 22 and the brake plate 10. The housing 76 would typically include a volume of fluid such as oil through which the disc 22 rotates as the axle 74 rotates, the disc 22 being fixed to rotate with the axle 74. The brake plate 10 is juxtaposed relative to the disc 22 so that the braking surface 14 and contact face 20 of scrapers 18 face the radial surface 78 of disc 22. The system 24 also includes an actuator (not shown) for axially moving the brake plate 10 relative to the disc 22, between an engaged position where the braking surface 14 is in contact with the radial surface 78 and a disengaged position in which the braking surface 14 is spaced from the radial surface 78. It is envisaged that the brake plate 10 would be spaced from the disc 22 so that in the disengaged position, the contact face 20 of the scrapers 18 would be in contact with the radial surface 78. Thus, the scrapers 18 act to continually scrape, wipe or otherwise remove fluid from radial surface 78. This substantially enhances the stopping power and efficiency of the brake system 24.

Now that embodiments of the present invention have been described in detail it will be apparent to those skilled in the relevant arts that numerous modifications and variations may be made without departing from the basic inventive concepts. For example, the brake plate 10 can be provided with any number of scrapers 18. Further, it is not an absolute requirement that a scraper 18 be provided between each pair of mutually adjacent sectors 60. Further, the contact face 20 of the scraper 18 can be formed without any groove or alternatively can be provided with multiple grooves in various patterns. The brake system 24 can also be provided with two brake plates 10, one on each side of the disc 22 so as to clamp the disc 22 therebetween during a braking operation. In this embodiment, a pair of diametrically opposed callipers can be provided for moving the brake plates 10 into the engaged position.

All such modifications and variations together with others that would be obvious to a person of ordinary skill in the art are deemed to be within the scope of the present invention, the nature of which is to be determined from the above description.

1. A brake plate adapted for use in a wet brake system having at least one disc rotatable about its axis through a volume of a liquid, said brake plate including at least:
a plate body;
a braking surface on one radial face of said plate body; and,
at least one scraping means supported by said plate body and axially moveable between a first position where the scraping means extends axially beyond said braking surface and a second position where said scraping means is retracted axially to lie substantially flush with or below said braking surface.

2. A brake plate according to claim 1 further including bias means for biasing said scraping means towards said first position.

3. A brake plate according to claim 1 or 2 wherein each scraping means has a radial contact face for face to face contact with said disc, to scrape or wipe liquid from said disc.

4. A brake plate according to claim 3 wherein said contact face is provided with a peripheral edge and at least one groove extending between and opening onto two spaced apart points on said peripheral edge, said at least one groove providing a flow path through which liquid can flow.

5. A brake plate according to claim 4 wherein said peripheral edge includes opposite first and second lateral edges and opposite first and second radial edges extending between said first and second lateral edges, and said at least one groove includes one or more grooves extending between and opening onto any two of said lateral and radial edges.

6. A brake plate according to any one of claims 1 to 5, wherein said braking surface is divided into a plurality of spaced apart sectors disposed circumferentially about said one radial face of said plate body and wherein one scraping means is disposed between at least one set of mutually adjacent sectors.

7. A brake plate according to claim 6 wherein each sector is provided with one or more grooves for providing corresponding flow paths for a liquid between two spaced apart points on a peripheral edge of said braking surface.

8. A wet brake system including at least:
a disc adapted for coupling to a rotatable component to rotate with said component about an axis, said disc having first and second opposite radial faces;
at least one brake plate according to any one of claims 1 to 7 said at least one brake plate fixed against rotation but linearly moveable relative to said disc parallel to said axis, said at least one brake plate disposed in facing relationship with one radial face of said disc;
means for axially moving said brake plate relative to said disc between an engaged position where said braking surface is in engagement with a facing radial surface and a disengaged position where said braking surface is spaced from said facing radial surface; and,
a sealed housing in which said disc and brake plate reside, said housing containing a volume of liquid through which said disc rotates.

9. A wet brake system according to claim 8 wherein said disc and said at least one brake plate are axially spaced when in the disengaged position, to the extent that said scraping means of said brake plate maintains contact with said facing radial surface of the disc.
